(19) United States
(12) Patent Application Publication
(10) Pub. No.: US 2005/0068154 A1
(43) Pub. Date: Mar. 31, 2005

(54) Method for identifying an individual module for short range wireless communication

(76) Inventors: Lutz Beste, Dornstadt (DE); Reza Serafat, Bochum (DE)

Correspondence Address: PERMAN & GREEN, 425 POST ROAD, FAIRFIELD, CT, 06824, US

(21) Appl. No.: 10/499,922

(22) PCT Filed: Dec. 21, 2001
(86) PCT No.: PCT/EP01/15217

(51) Int. Cl. H04Q 7/00

(52) U.S. Cl. 340/7.2; 455/466

(57) ABSTRACT

The present invention relates to a method of identifying an individual module for short range wireless communication. To facilitate identifying people to be contacted the method comprises the steps of: transferring at least identification information of a first module (13) to be found to a second module (13), transmitting identification information by the first module (13), screening the environment by the second module (13) for the first module (13) by comparing received information with the identification information of the first module (13), and outputting an alarm signal indicating that the first module (13) has been found in the average area of the second module (13).

### DESCRIPTION

The present invention relates to a method of identifying an individual module for short range wireless communication.

### BACKGROUND OF THE INVENTION

Modules for short range wireless communication or data transfer becomes more and more popular as interfaces for connecting different electronic devices for data transfer. In particular, infrared interfaces are commonly use for connecting a main unit like a personal computer with corresponding subunits like printer, keyboard, mouse, monitor and the like. Further, low power radio frequency (RF) modules are used more and more instead of infrared interfaces because they do not need to be directly visible for each other.

Wireless interfaces for data transfer, infrared interfaces as well as RF interfaces are also provided in hand-held computers and mobile terminals of telecommunications networks to transfer data from a first device to a second and vice versa.

If two or more people who don't know each other try to meet at crowded places, e.g. in business life at a meeting point on international fairs or in private life for a blind date at a restaurant, special signs are usually used which the participants of the intended meeting or date agreed upon in advance. However, sometimes it is not easy to find a suitable identification sign and/or to identify the sign reliably.

### SUMMARY OF THE INVENTION

Therefore, it is an object of the present invention to provide a method of identifying an individual module for short range wireless communication that facilitates identifying people to be contacted.

This object is accomplished by the method according to claim 1. Advantageous refinements and developments of the invention are described in the dependent claims.

According to the present invention a method for identifying an individual module for short range wireless communication that is owned by a person to be found comprises the steps of transferring at least identification information of a first module to be found to a second module, transmitting identification information by the first module, screening the environment by the second module for the first module by comparing received information with the identification information of the first module, and outputting an alarm signal indicating that the first module has been found in the coverage area of the second module.

If two people who don't know each other want to meet and own a suitable module for short range wireless communication it is only necessary to transfer an identification code of one of the modules to the other. This can be done in advance when the intended meeting is appointed. Thereafter, near the meeting point at the appointed time both people has to switch their modules into an identifying mode to perform identification operation. During identification operation one of the modules transmits its identification information whereas the other module compares received information with the identification code of the module to be found and indicates that the wanted module has be found when the received information matches the stored information.

For indicating that the other module has been found an alarm signal is output to the user so that he knows that the person to be met is near to him/her.

To facilitate the communication between the modules it is provided that the identification information is broadcast by the module to be found.

Although, it is possible that only one module is searching for another and to send a “found”-information to the searched module upon identification so that the other module can also output an alarm signal to its user it is preferred that at least identification information of both the first and the second module is respectively transferred to the other module, and both modules are transmitting identification information and are screening the environment for the other one.

To facilitate the data transfer from one module to another when arranging an appointment or a date, identification information of the modules is transferred to the other ones via a telecommunications network by means of respective terminals which the modules are respectively connected with. In particular, for transferring and/or exchanging identification information via a telecommunications network a short message service (SMS) or a multimedia messaging service (MMS) can be used.

The inventive method can be used also for a special contact service that may be offered by a service provider for informing subscribers of this special service that another person having the same interests is in the same area. For this purpose identification information is transferred to modules owned by subscribers of a specific contact service from a service provider station via the telecommunications network if subscribers of similar interests are substantially at the same location.

Thus, if two people both interested in the same sport and interested in meeting other people are in the same location, e.g. in the same restaurant the respective identification information is respectively send to the modules of these people, e.g. via SMS or MMS. Then, each of them can decide whether or not he/she wishes to contact the other one and can activate the module for performing searching and identification operation.

To ensure reliably identification of a wanted module, identification information comprises at least an identification number of the module to be found, wherein according to a preferred development of the invention identification information comprises a unique identification number of a RF module operatus according to the Blue Tooth standard.

Further, it is possible that identification information comprises a specified key defined by the user or generated by concatenating identification numbers of the modules or subscriber numbers related with associated terminals of a telecommunications network.

According to an advantageous refinement of the present invention additional information specifying the module to be found in a comprehensible manner is transferred together with the identification information. Thus, it is possible to activate the module for searching another one correctly in particular in case that identification information is stored for two or more intended meetings.

In case that the module of the partner to be met has been found, the alarm signal is output as tactile, acoustical or visual signal or a combination thereof, wherein additional information can be output together with the alarm signal.

Further, it is possible, that the distance to the module to be found is indicated by the alarm signal itself or by additional information.

### BRIEF DESCRIPTION OF THE DRAWINGS

The invention will be explained in more detail hereinafter with reference to the accompanying drawings.

FIG. 1 shows a simplified, schematic block diagram for illustrating the configuration of communications systems used with the present invention, and

FIG. 2 shows a similar diagram as FIG. 1 illustrating another configuration of the telecommunications system.

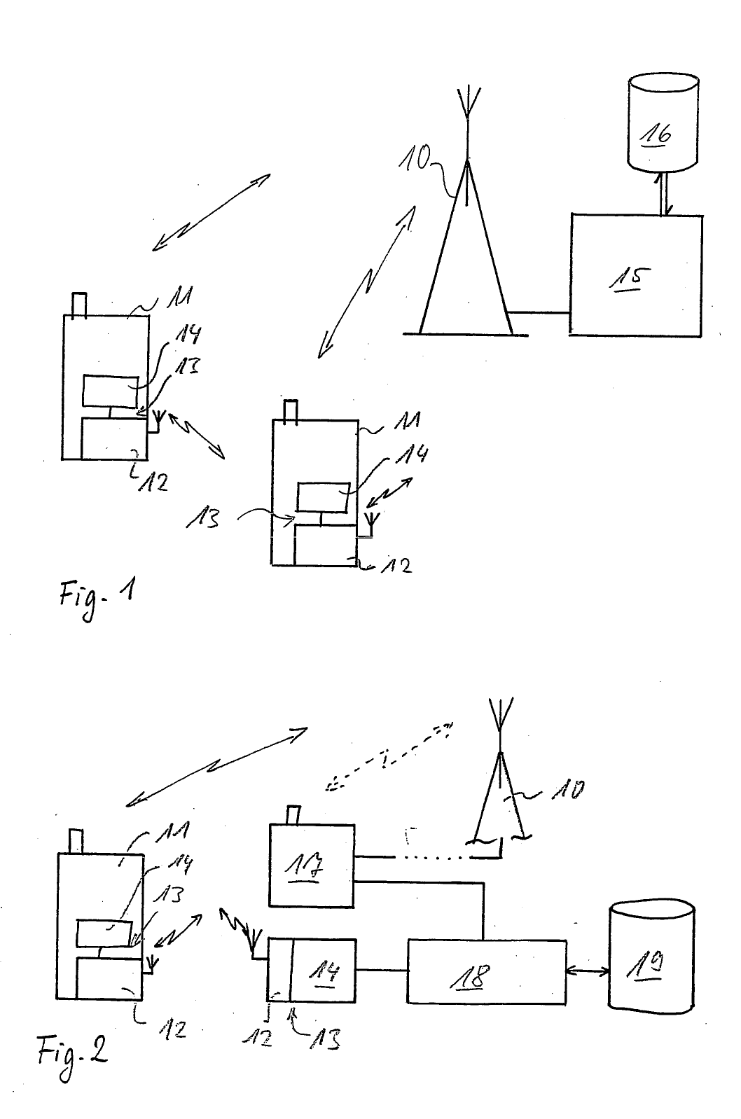

Mutually corresponding components are provided with the same reference symbols in the various figures of the drawings.

### DETAILED DESCRIPTION OF THE PREFERRED EMBODIMENTS

At first, the present invention will be explained in relation to a telecommunications network having a base station 10 and a plurality of mobile subscriber terminals 11, simply called mobile phones in the following description.

Each mobile phone 11 is provided with a short range wireless communication interface 12 that forms a short range wireless communication module 13 together with a control unit 14 of the mobile phone 11. The short range wireless communication interface 12 and module 13 are preferably implemented according to the Blue Tooths standard and will be called here in after simply as Blue Tooth interface 12 and Blue Tooth module 13.

If two or more people who own a mobile phone 11 with a Blue Tooth module 13 want to meet but do not know each other they have to simply exchange identification information, in particular the unique Blue Tooth identification number of the Blue Tooth modules 13 for example by using SMS or MMS. When the meeting partners reach the meeting point they have to activate their Blue Tooths modules 13 of their mobile phones 11 for performing, searching and identification operation. In this mode their Blue Tooth modules 13, i.e. the control units 14 of the mobile phones 11 using the Blue Tooth interface 12 for transmitting and receiving data, will screen the environment for available Blue Tooth devices. Each of the Blue Tooths modules 13 transmit identification information identifying itself preferable by broadcasting and compares received identification information with the stored identification information of the Blue Tooth module 13 to be searched. Thus, both Blue Tooth modules 13 check whether the searched module is available in its respective coverage range or not.

After detecting the searched Blue Tooth module 13 the mobile phone 11 starts immediately to output an alarm signal by flashing, vibrating or by playing a special ringing tone to indicate that the meeting partners are within the Blue Tooth coverage area of their modules 13. This means that the meeting partners are within an area with a radius of maximum 50 m.

In this way people who want to meet could find each other easily.

To further facilitate identifying the meeting partner, the alarm signal will indicate the distance between the two Blue Tooth modules in question for example by the loudness of an acoustical signal or by the flashing frequency of a visual alarm signal. Furthermore, an approximated value of the distance can be output on the display of the mobile phone 11.

Beside the described application of the inventive method for meeting unknown people, the inventive method enables a new service that can help people having the same interests and being in the same area to meet each other.

Therefore, people who want to use this service have to submit identification information of the Blue Tooth module 13 of their mobile phones 11 to a service provider 15 together with a profile of interests, e.g. information on their hobbies, professions, and the like. The profile of interests will be stored in a data base 16 on the service provider side.

The mobile phone 11 of a subscriber of this special service will be tracked by the service provider using any suitable position finding method that can determine the position of the mobile phone 11 with an accuracy that is comparable with the coverage area of the Blue Tooth module 13 or better.

If two subscribers of this special service having the same interests are within a certain area at the same time both will be informed about the presence of the other and provided with the necessary identification information. Thereafter, they can activate the searching and identification operation of their Blue Tooth modules 13 of their mobile phones 11 to get in touch with each other.

Another use of the present invention will be explained in connection with FIG. 2. This application of the invention relates to mobile business. A customer who owns a mobile phone having a Blue Tooth module 13 enabled to perform searching and identification operation similar to that described above can make, e.g. reservations in a restaurant or for theater tickets via his mobile phone 11 (for example using the internet via WAP). Therefor the customer send identification information, for example the unique Blue Tooth identification number of his/her Blue Tooth module 13, together with her/his reservation order to the restaurant or the ticketing company. At the restaurant or ticketing company side the identification information is received together with the reservation order via a terminal 17 of a wireless or wired telecommunications network. The received information is handled by a control unit 18 and stored in a data base 19.

For identifying the customer a Blue Tooth module 13 having a Blue Tooth interface 12 and a control unit 14 is provided at the restaurant and the ticket counter side of ticketing company or theater.

The Blue Tooth module at the restaurant or ticket counter side continuously screen the environment for available Blue Tooth modules transmitting identification information. The received identification information will be compared with identification information stored at the restaurant or ticketing company side together with respective reservation orders.

If an active Blue Tooth module has been identified in the coverage area of the module of the restaurant or ticket counter, the customer who owns the identified Blue Tooth module can identify himself by showing his mobile phone 11 flashing or ringing at the restaurant or ticket counter. Since the order is stored in the data base 19 together with the identification information the operator at the counter of the ticketing company or theater could easily find out what was the customers order and serve her/him.

1. A method of identifying an individual module for short range wireless communication, comprising the steps of:
transmitting identification information by a first module (13) to be found by a second module (13),
screening the environment by the second module for the first module by comparing received information with the identification information of the first module, and
outputting an alarm signal indicating that the first module has been found in the coverage area of the second module,
characterized by transferring at least identification information of the first module (13) to be found to the second module (13) by the first one prior to searching the first module (13) by the second module (13).

2. The method as claimed in claim 1, characterized in that the identification information is broadcast by the module (13) to be found.

3. The method as claimed in claim 1, characterized in that at least identification information of both the first and the second module (13) is respectively transferred to the other module, and both modules are transmitting identification information and are screening the environment for the other one.

4. The method as claimed in claim 1, characterized in that identification information of the modules (13) is transferred to the other ones via a telecommunications network by means of respective terminals (11) which the modules (13) are respectively connected with.

5. The method as claimed in claim 4, characterized in that identification information is transferred to modules owned by subscribers of a specific contact service from a service provider station via the telecommunications network if subscribers of similar interests are substantially at the same location.

6. The method as claimed in claim 1, characterized in that identification information comprises at least an identification number of the module (13) to be found.

7. The method as claimed in claim 6, characterized in that identification information comprises a unique identification number of a module operating according to the Blue Tooth standard.

8. The method as claimed in claim 1, characterized in that identification information comprises a specified key defined by the user or generated by concatenating identification numbers of the modules or subscriber numbers related with associated terminals of a telecommunications network.

9. The method as claimed in claim 1, characterized in that additional information specifying the module to be found in a comprehensible manner is transferred together with the identification information.

10. The method as claimed in claim 1, characterized in that the alarm signal is output as a tactile, acoustical or visual signal of a combination thereof.

11. The method as claimed claim 10, characterized in that additional information is output together with the alarm signal.

12. The method as claimed in claim 10, characterized in that the distance to the module to be found is indicated by the alarm signal itself or by additional information.
